(19) United States
(12) Patent Application Publication
(10) Pub. No.: US 2019/0136627 A1
(43) Pub. Date: May 9, 2019

(54) FIXED SERVICE LADDER

(71) Applicant: Superlatik Oy, Mikkeli (FI)

(72) Inventor: Kyösti IKONEN, Mantyharju (FI)

(21) Appl. No.: 16/035,842

(22) Filed: Jul. 16, 2018

(30) Foreign Application Priority Data
Jul. 17, 2017 (FI) U20174186

(51) Int. Cl. E06C 9/08; E06C 1/383; E06C 7/00

(52) U.S. Cl. CPC E06C 9/085; E06C 7/006; E06C 1/383

(57) ABSTRACT

A fixed service ladder that has: a body attachable to a building; rungs attachable to the body as ladder steps; and side rails. The fixed service ladder has a use configuration, in which the fixed service ladder is in its use configuration, and for implementing a climbing hindrance, a retracted configuration, in which the rungs are turned closer to each other and to an angle differing from horizontal. The body has for each rung a first joint to which the rung joins allowing vertical pivoting; and for at least two different rungs restraints restraining said rungs in the use configuration. The rungs have second joints for pivotable joining with the side rails outside the body.

### TECHNICAL FIELD

The aspects of the disclosed embodiments generally relate to a fixed service ladder.

### BACKGROUND ART

Fixed service ladders facilitate safe and quick access onto a roof for chimney sweepers, firemen and other people needing access to the roof. The fixed service ladders must enable not only climbing to the roof but also carrying along necessary tools such as chimney sweeping, service and fire extinguishing equipment.

Aside from apparent advantages of a fixed service ladder there is a disadvantage that they enable unauthorized access to the roof. Unauthorized climbing onto the roof endangers not only a climber himself but also people moving near the building (risk of inadvertent or intentional dropping of things) and roof structures (damaging rooftop, vandalism, breaking in into attic based storages through a roof hatch). An intruder who has penetrated into a building via the fixed service ladder may also cause serious damage by setting a destructive fire in the building, for example.

Attempts have been made to prevent unauthorized use of fixed service ladder by installing a climbing hindrance to a lower end of the ladder. In case of fire escape ladder intended for temporary access, the lower end of the ladder can be left that high up that it is difficult to get onto the ladder from the ground and furthermore, fire escape ladders do not typically enable access onto the roof but only next to a window, for example. The purpose of fixed service ladder yet necessitates that the ladder must reach that far down that they can be climbed up without undue burden also with, e.g., a chimney sweeping vacuum cleaner. In fixed service ladders of public buildings and blocks of flats, there is often mounted as a climbing hindrance a lockable plate onto the ladder, which plate can be removed or moved aside by releasing a lock pin. On the other hand, the plate used as a climbing hindrance is relatively short and a fit person may also succeed to climb past the climbing hindrance using some ancillaries, for example.

In addition to the fixed service ladder, fire escape ladders are often mounted to the walls of buildings, such as an openable ladder of PP product, see https://pp-tuote.fi/product/aukaistava-tikas/. Such an openable ladder must be openable in case of fire immediately from the exit height e.g. by removal of a safety pin. While the openable ladders are not intended for a service ladder, they would not suit to that purpose either, as an openable fire escape ladder cannot easily be taken into use from below by a chimney sweeper, for example. Openable fire escape ladders are also rather delicate for use as fixed service ladders, because only their wall-side end is pivotably attached to a narrow wall body and an outer side rail rests against the ground. Such ladders are the more wobbly in terms of movement parallel to the wall the farther apart they are from the support obtainable from the ground. Moreover, the structure of the openable fire escape ladders provides only on the outer edge a side rail for grabbing by a person using the ladder. On the wall side, one has to grab the rungs, which results in a worse grip.

It is an object of the disclosed embodiments to provide fixed service ladder that can be retracted for saving space and/or preventing unauthorized use.

### SUMMARY

According to a first aspect of the disclosed embodiments, there is provided a fixed service ladder of claim 1 that comprises:
a body attachable to a building;
rungs attachable to the body as ladder steps; and
side rails. The fixed service ladder is characterized in that:
the fixed service ladder has a use configuration, in which the fixed service ladder is in its use configuration, and for implementing a climbing hindrance, a retracted configuration, in which the rungs are turned closer to each other and to an angle differing from horizontal;
the body comprises for each rung a first joint to which the rung is arranged to join allowing vertical pivoting;
the body comprises at least two different rungs restraints configured to restrain said rungs in the use configuration; and
the rungs comprise second joints for pivotable joining with the side rails outside the body.

Preferably, the fixed service ladder comprises blocking means for preventing moving the fixed service ladder from the retracted configuration to the use configuration, which blocking means comprise locking means for locking the fixed service ladder to the retracted configuration or means for preventing operation of the restraints so that the restraints would not hold the rungs in their use configuration.

Preferably, in the retracted configuration, the rungs are pivoted diagonally up.

Since the body of the fixed service ladder comprises first joints for the rungs and restraints for restraining the rungs in the use configuration, the rungs supported to the body via the restraints increase torsional stiffness of fixed service ladder in the use configuration of the fixed service ladder. Preferably, the body comprises said restraints for all the rungs.

Preferable, the fixed service ladder are configured to be mountable such that the fixed service ladder are separated from the ground in the retracted configuration and in the use configuration. Mounting separated from ground may avoid that ground raised by frost in the ground or snow and ice accrual under the fixed service ladder would prevent moving the fixed service ladder to its use configuration.

Preferably, the body comprises two sides that are interconnected such that inner ends of the rungs can pivot between the sides. Preferably, the sides are made of aluminum plate. Alternatively, the plates are made of steel plate.

Preferable, the sides are interconnected with the restraints. Preferably, each restraint comprises a bushing that defines spacing between the sides, and screws such as bolts that extend through the plates and the bushings. The bushing may comprise aluminum, steel, plastics such as polyethylene, or rubber, for example.

The body may be configured to bear entirely the strain directed to the fixed service ladder. The body may comprise wall attachments for wall mounting. The wall attachments may be formed by brackets attached to or formed in the sides. Alternatively, a uniform mounting plate may be attached to the sides. The sides and the mounting plate may be formed of a U-profile. Alternatively, one or both of the sides may be formed of an L-profile such that one planar surface of the profile operates as a side and another planar surface operates as the mounting plate.

The fixed service ladder may comprise the restraints for all the rungs. The restraint may comprise a bushing such as an aluminum, steel or a plastics bushing. The restraint may comprise a screw fitted as an axle of the bushing. Preferably, the bushing protects surface treatment of the rung. Thanks to the bushing, the screw can be used to tighten the sides tightly without preventing smooth movement of the rungs in the space between the sides.

Preferably, the fixed service ladder comprises a safety rail. The fixed service ladder may comprise the safety rail between the side rails. Alternatively, the side rail may be configured to function also as a safety rail. The safety rail may be configured to receive a safety shuttle that in case of falling clings to the safety rail.

Preferably, the locking means comprise an aperture formed in the body for receiving a locking pin through the body for locking the rung to an uplifted position.

Preferably, the locking means comprise means for locking the rung to the use position.

Preferably, same means can prevent the moving of the fixed service ladder from the retracted configuration to the use configuration and from the use configuration to the retracted configuration.

The locking pin may be wedge ended for reducing play.

The locking pin may be a lockable cotter. The locking pin may be a padlock shackle. The locking pin may be a pin of a pin lock. By locking a sprung to the use position, mischievous prevention of use of the fixed service ladder may be prevented while the user of the fixed service ladder is on the roof.

Alternatively, the locking means comprise a controllable switch such as an inhibitor or latch that is actuatable by a first operating device from a lower end of the fixed service ladder. The controllable switch may be operable also for releasing a second use device at an upper part of the fixed service ladder, such as at a higher floor or at the roof or near the roof. The second use device may be arranged to enable moving the fixed service ladder to the use configuration without a key or tools so that the fixed service ladder could also be used as a fire escape ladder if necessary. In embodiments, in which the fixed service ladder is locked to a retracted configuration, the controllable switch could be a stopper that prevents pivoting of the rungs and on releasing allows the rungs to turn into their use configuration. In an alternative embodiment, the fixed service ladder is freely moveable to its use configuration, but can only be caused to stay there by moving the controllable switch to a position in which it prevents the sides from turning away from their use configuration during the use of the fixed service ladder i.e. at least limits the pivoting of the rungs downwards from their use configuration.

The side rails and/or rungs may be capped at an end that is higher when the fixed service ladder is retracted.

The fixed service ladder may be formed of two or more fixed service ladder modules to attain a fixed service ladder of desired length. The side rails may comprise reductions and/or bolt attachments to interconnect side rails of sequential fixed service ladder modules. A module length may be 2000 mm to 6000 mm, e.g. 3000 mm or 4000 mm.

The side rails and/or the rungs may be of oval pipe. The rungs may be mounted with a wider side upright. Mounting the rungs wide side up may increase vertical load capacity of the fixed service ladder.

The rungs may be supported to the sides of the body in the use configuration over a distance the length of which is at least 2 or 2.5 or 3 times the greatest diameter of the pipe. The rungs may have a length of 450 mm to 1200 mm, e.g. more than 800 mm. The rungs may be powder painted steel. The side rails may be connected to the rungs by bolts, e.g., with bolts made of stainless steel or acid-resisting steel.

The sides may have a width (depth e.g. when mounted on a wall) of at least 100 mm to 250 mm, preferably 140 mm or 150 mm.

Different embodiments of the present disclosure are described or have been described in the foregoing only with reference to some example aspect or aspects of the present disclosure. A skilled person appreciates that an embodiment of any aspect may be applied in the same or other aspects either alone or in combination with other embodiments.

### BRIEF DESCRIPTION OF THE DRAWINGS

Some example embodiments of the present disclosure will be described with reference to the accompanying drawings.

FIG. 1 shows a fixed service ladder according to an example of the present disclosure in a use configuration, seen from the front;

FIG. 2 shows a fixed service ladder according to an example of the present disclosure in a retracted configuration, seen from the front;

FIG. 3 shows a fixed service ladder according to a first embodiment, seen from the top;

FIG. 4 shows a body of a fixed service ladder according to a second embodiment, seen from the front;

FIG. 5 shows a body of a fixed service ladder according to a third embodiment, seen from the front;

FIG. 6 shows details of the fixed service ladder of FIG. 1 without side rails and a safety rail;

FIG. 7 shows from behind a view of the body, rungs and restraints of the fixed service ladder of FIG. 1; and

FIG. 8 shows from behind a view of alternative body, rungs and restraints of the fixed service ladder of FIG. 1.

### DETAILED DESCRIPTION

In the following description, like reference signs denote like elements or steps. It should be observed that the Figs. are not entirely in scale and that they mostly serve an illustration purpose of some embodiments of the present disclosure.

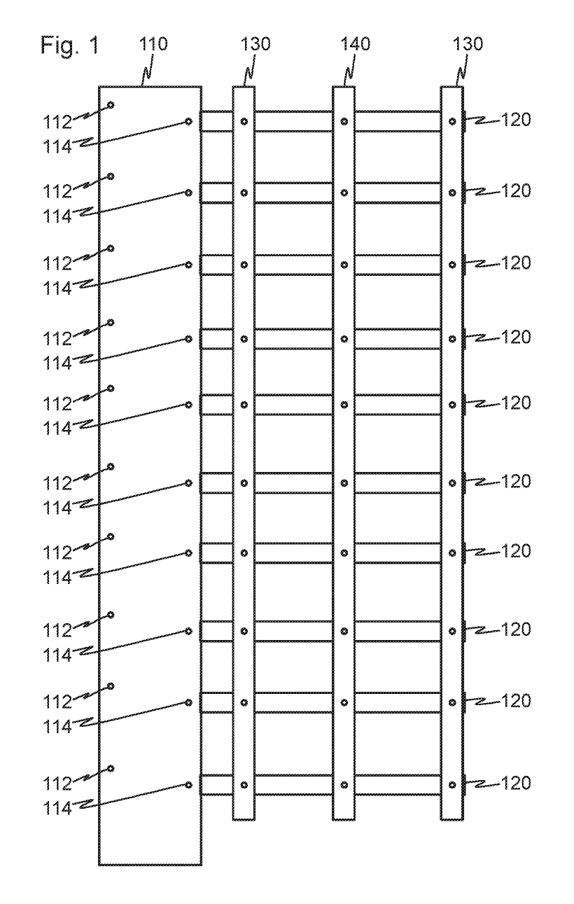

FIG. 1 shows a fixed service ladder according to an example of the present disclosure in a use configuration, seen from the front. The fixed service ladder comprises a body 110 that is attachable to a building; rungs 120 attachable to the body as ladder steps; side rails 130; and in case of fixed service ladder rising to high up, also a safety rail 140, e.g., between the side rails 130, such as in the middle of the space between the side rails 130.

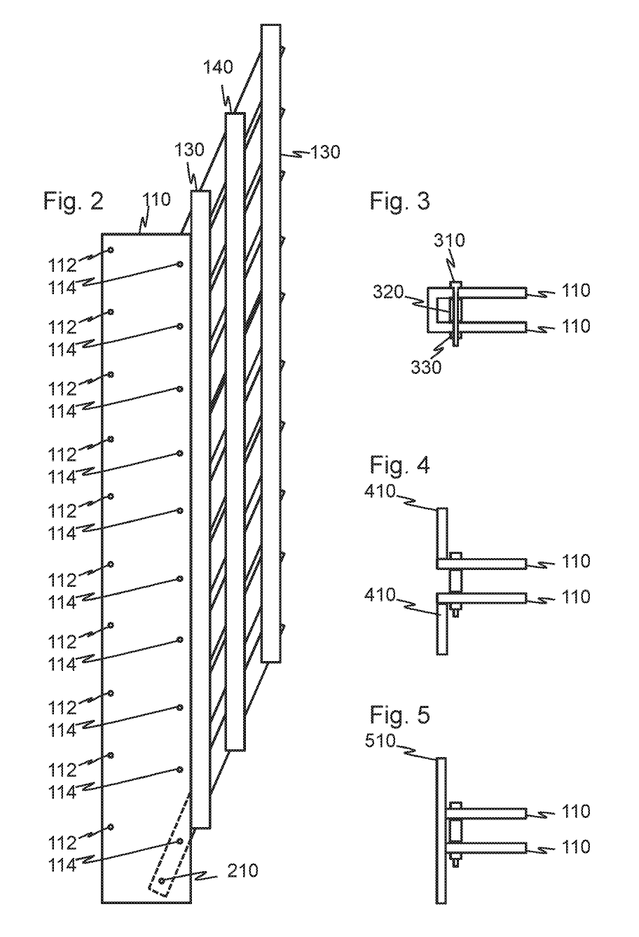

The fixed service ladder has a use configuration, in which the fixed service ladder is in its use configuration, as drawn in FIG. 1, and for implementing a climbing hindrance, a retracted configuration, in which the rungs 120 are turned closer to each other and to an angle differing from horizontal, as shown in FIG. 2.

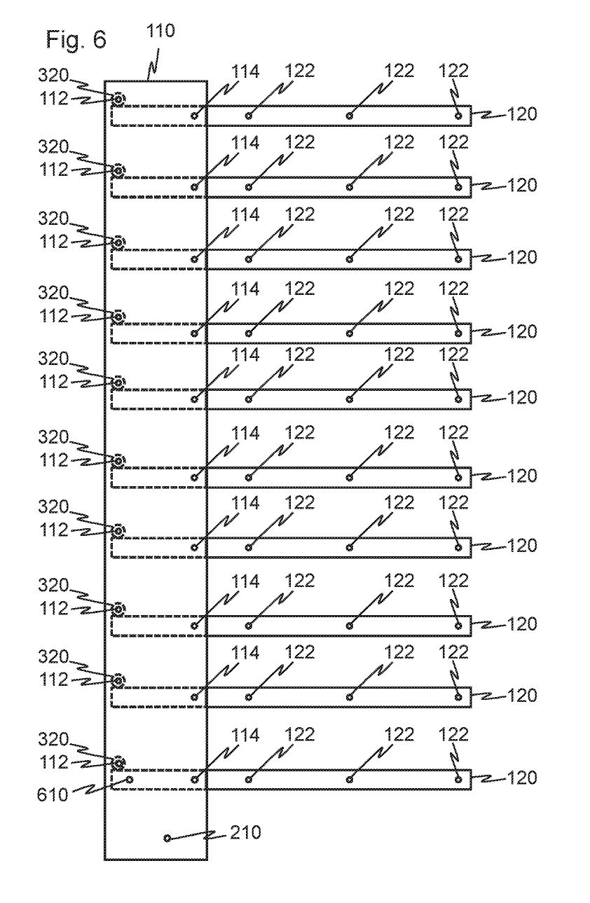

The body 110 comprises for each rung 120 a first joint 114 (or more accurately a hole of a joint), to which the rung 120 is arranged to join allowing vertical pivoting. Additionally, the body 110 comprises for at least two different rungs 120 restraints 130 shown in FIG. 6 and the holes 112 drawn in FIG. 1 for them configured to restrain said rungs in the use configuration. The rungs 120 comprise second joints for pivotable joining with the side rails 130 and the safety rail 140 outside the body 110.

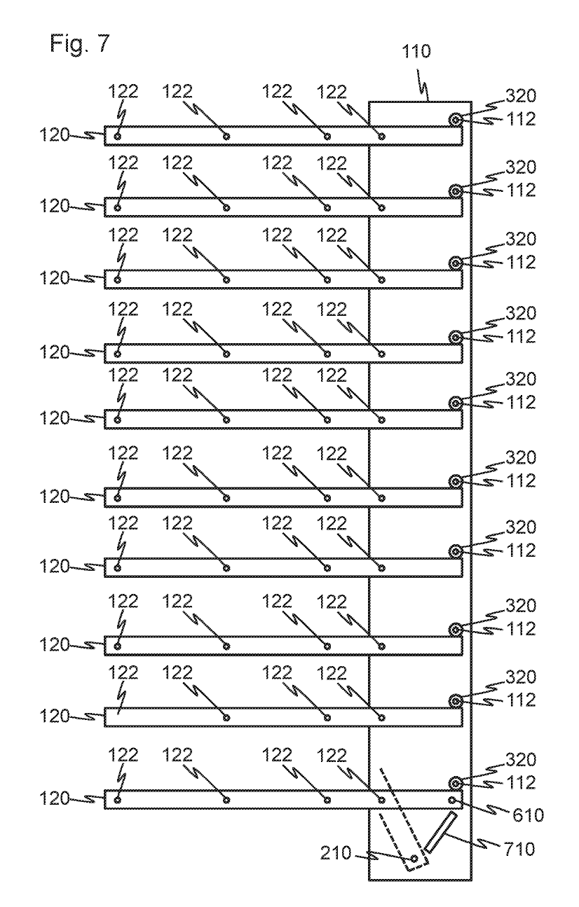

The fixed service ladder further comprises blocking means for preventing moving the fixed service ladder from the retracted configuration to the use configuration. The blocking means comprise locking means for locking the fixed service ladder to the retracted configuration or means for preventing operation of the restraints so that the restraints would not hold the rungs in their use configuration. The fixed service ladder of FIGS. 1 to 7 is designed to retract with the rungs 120 obliquely up so that the restraints 320 that appear in FIGS. 3, 6 and 7 are, e.g., parts fixedly mounted of the body. In this case, it is not attempted to prevent the functioning of the restraints but the removing of the fixed service ladder from its retracted configuration. For example, to this end it is possible to use, e.g., a locking pin seen in FIGS. 2, 6 and 7 that locks the rung through a lock hold 210 obliquely upwards. Alternatively, the lock hole 210 can be omitted and, e.g., a lock member 710 (FIG. 7) can be positioned against the side of the rung 120 to prevent pivoting of the rung 120. With a suitable positioning and size of the lock member 710, pivoting of the rung 120 can be limited as desired both towards the retracted configuration and the use configuration. The lock member 710 of FIG. 7 is a plate that is lockable in its place through the body and removable therefrom, for which plate suitable holes are made to the sides of the body.

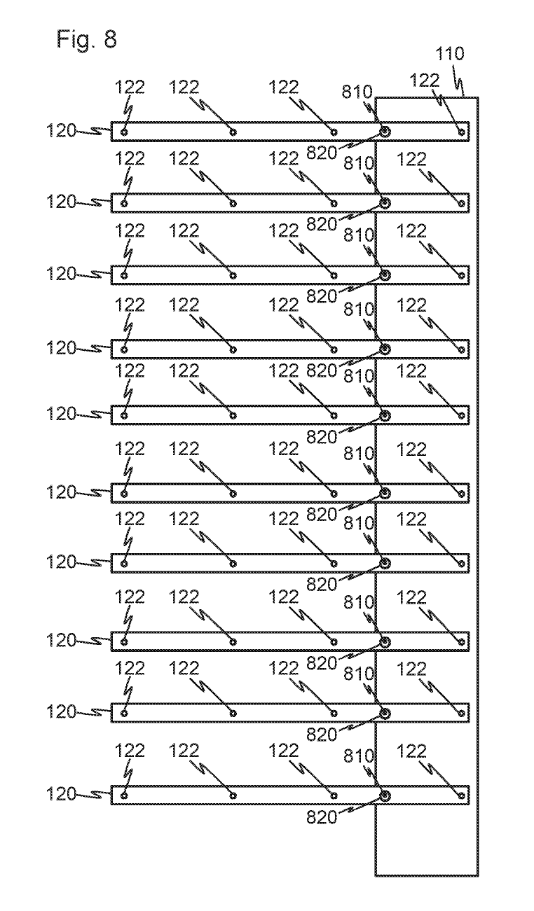

According to an embodiment, the fixed service ladder is implemented such that the restraints 320 are not fixed but, for example, pivotable with a hinged secondary body is pivotable through holes made in the body (and possibly also in the rungs). FIG. 8 shows an example in which, a restraint pin can be brought through holes made in the side of the body for many (here all) rungs 120 and possibly through a hole 820 in the rung 120 through the body (e.g. through both sides and the through or under the rung 120) such that the rung cannot lower down. In FIG. 8, also the joints of the rungs 120 are changed to the inner side. The releasable restraints then enable easy pivoting of the rungs 120 to a very steep angle, e.g. 60 to 80 degrees from horizontal. By all means, the joints can be also arranged optionally on the outer or inner side (considering the inner side to be the side of the body that is closer to the wall, if the fixed service ladder is mounted to the wall in a perpendicular angle).

In case of FIG. 8, turning the fixed service ladder to the use configuration is not necessarily in itself prevented, but the fixed service ladder cannot be climbed, because they would turn back down immediately when not held in their use configuration, until the releasable restraints 810 are again brought into a restraining state. As a simple implementation possibility for the releasable restraints, there is provided a joint comb-like plate part that is pivotable and lockable to be in direction of the body and pivotable (and preferably lockable) to be perpendicular to the rungs 120 such that the rungs rest on teeth corresponding to fingers of a comb on the comb-like plate part.

FIG. 2 shows from the front the fixed service ladder of an embodiment in its retracted configuration, such as the fixed service ladder of FIG. 1, but in sake of simplicity, without the joint points 122 (FIG. 6) of the side rails 130 and the safety rail 140. As mentioned in the foregoing, a lock hole 210 is seen in the body of FIG. 2 or more particularly in the lower part of the second side. In FIG. 2, there is further seen, a portion of a lowest rung 210 that is behind the body and marked by a dashed line, which portion is here used for locking the fixed service ladder to its retracted configuration. In order to make it difficult to break the fixed service ladder mischievously the body 110 (sides) is preferably reinforced in a region of (e.g. the lowest) rung 120 joint 114 and the region of the lock hole so that the sides would not have to be made unnecessarily sturdy over their entire length. The rung used for locking may be stronger than others over its entire length or at a portion used for the locking.

FIG. 3 shows a fixed service ladder according to a first embodiment, seen from the top. In this case, the body is implemented with a U-profile and the mounting to a building is done, for example, through a bottom of the U-profile. Alternatively, the shape of FIG. 3 can be done, e.g., by joining three plate parts by welding. FIG. 3 shows a restraint 310 that comprises a through bolt, such as an 8 mm machine screw, a bushing 320, such as a piece of a polyethylene bar with a hole drilled to the middle of which, and a nut 330, such as a lock nut (e.g., nyloc). Especially if the fixed service ladder is mounted to a wall direction, the mounting can be implemented also at one of the sides. For example, in case of FIG. 3, a suitable screw can then be used as a screw of the restraint, with which screw the body is mounted, e.g., to an offsetting profile mounted to the wall, with which offsetting profile the fixed service ladder are brought to a desired distance from the wall. Ordinary steel-made fixed service ladders are brought significantly apart of the wall to account for an overhang of a roof pane and hung from up to the roof pane. A corresponding solution can also be used with the present invention using a suitable attachment of the body. It is conceivable for sideways support that the outer side rail and/or the rungs 120 then are supported by a wall support made for an outer edge.

FIGS. 4 and 5 show two alternative body structures seen from top. In sides of FIG. 4, there is welded or screwed (directly or with angle irons) attachment brackets or a wall mounting plate that extends over a longer distance. Alternatively, one or more sides can be formed of an L-profile. On the other hand, in FIG. 5, a uniform wall mounting plate is attached behind the sides, e.g., by plating, screws, or by angle irons and screws.

FIGS. 6 and 7 show, from the front and behind, details of the fixed service ladder of FIG. 1 in the use configuration without the side rails 130 and the safety rail 140. In these Figs., there is presented the lock pin 210 mentioned in the foregoing for locking the fixed service ladder in its retracted configuration, e.g., by a lockable cotter. Further, FIGS. 6 and 7 show a use configuration securing hole, to which a lock of the fixed service ladder (e.g., a lockable cotter) is attachable, when it is desired to ensure that no-one would mischievously turn the fixed service ladder up and tie in its upper position, e.g., by pushing a suitable object to the lock hole 210.

Each rung 120 of the fixed service ladder described in the foregoing strengthens in part the fixed service ladder sideways and the side rails 130 and possibly attached safety rail 140 form of the rungs 120 a structure that reinforces the fixed service ladder sideways and shares vertical load onto the restraints 310. Thus, stress caused by one rung 120 to the body or the number of restraints 320 can be reduced.

The foregoing description provides non-limiting examples of some embodiments of the invention. It is however clear to a person skilled in the art that the invention is not restricted to presented details but that it can be implemented in other equivalent ways.

Some of the features of the afore-disclosed embodiments of this present disclosure may be used to advantage without the corresponding use of other features. The foregoing description shall be considered as merely illustrative of principles of the present disclosure, and not in limitation thereof. Hence, the scope of the present disclosure is only restricted by the appended claims.

1. A fixed service ladder that comprises:
a body attachable to a building;
a plurality of rungs attachable to the body as ladder steps; and
side rails; wherein
the fixed service ladder has a use configuration, in which the fixed service ladder is in its use configuration, and for implementing a climbing hindrance, a retracted configuration, in which the rungs are turned closer to each other and to an angle differing from horizontal;
the body comprises for each rung a first joint to which the rung is arranged to join allowing vertical pivoting;
the body comprises for at least two different rungs restraints configured to restrain said rungs in the use configuration; and
the rungs comprise a plurality of second joints for pivotable joining with the side rails outside the body.

2. The fixed service ladder of claim 1, wherein the fixed service ladder further comprises blocking means for preventing moving the fixed service ladder from the retracted configuration to the use configuration, which blocking means comprise locking means for locking the fixed service ladder to the retracted configuration or means for preventing operation of the restraints so that the restraints would not hold the rungs in their use configuration.

3. The fixed service ladder of claim 2, wherein the locking means comprise an aperture formed in the body for receiving a locking pin through the body for locking the rung to an uplifted position.

4. The fixed service ladder of claim 2, wherein the locking means comprise a controllable switch that is actuatable by a first operating device from a lower end of the fixed service ladder and by a second operating device from an upper part of the fixed service ladder for enabling using the fixed service ladder as a fire escape ladder.

5. The fixed service ladder of claim 1, wherein the body comprises said restraints for all the rungs.

6. The fixed service ladder of claim 1, wherein the body comprises two sides that are interconnected such that inner ends of the rungs can pivot between the sides.

7. The fixed service ladder of claim 6, wherein the sides are interconnected with the restraints.

8. The fixed service ladder of claim 1, wherein the body is configured to bear entirely the strain directed to the fixed service ladder.

9. The fixed service ladder of claim 1, wherein the restraint comprises a polyethylene bushing.

10. The fixed service ladder of claim 1, wherein the fixed service ladder is formed of two or more fixed service ladder modules to attain a fixed service ladder of desired length.

11. The fixed service ladder of claim 1, wherein the rungs are supported to the sides of the body in the use configuration over a distance the length of which is at least 2 or 2.5 or 3 times the greatest diameter of the rungs.
